(19) United States
(12) Patent Application Publication
(10) Pub. No.: US 2006/0169339 A1
(43) Pub. Date: Aug. 3, 2006

(54) Microvalve device and apparatus adopting the same

(76) Inventors: Kwang-wook Oh, Gyeonggi-do (KR); Young-sun Lee, Gyeonggi-do (KR); Jung-im Han, Seoul (KR)

Correspondence Address: CANTOR COLBURN, LLP, 55 GRIFFIN ROAD SOUTH, BLOOMFIELD, CT, 06002, US

(21) Appl. No.: 11/346,452

(22) Filed: Feb. 2, 2006

(30) Foreign Application Priority Data
Feb. 2, 2005 (KR) 10-2005-0009742

(51) Int. Cl. F15C 1/04

(52) U.S. Cl. 137/827

(57) ABSTRACT

A microvalve device is provided. The microvalve device uses electrolysis and uses a hydrogel swelling and deswelling in response to anions or cations as an actuator for controlling the path of a flowing fluid. The microvalve device does not require a buffer solution but uses the transfer fluid flowing in a valve as a source driving the actuator. To generate the anions or cations, an electrode is needed for electrolysis of the fluid near the hydrogel. The microvalve is easy to manufacture and has a simple structure. In addition, the micro valve is useful to manufacture fluid channel arrays having various multi-channel structures.

### CROSS-REFERENCE TO RELATED PATENT APPLICATIONS

This application claims the benefit of Korean Patent Application No. 10-2005-0009742, filed on Feb. 2, 2005, in the Korean Intellectual Property Office, the disclosure of which is incorporated herein in its entirety by reference.

### BACKGROUND OF THE INVENTION

1. Field of the Invention

The present invention relates to a microvalve device and an apparatus adopting the same, and more particularly, to a microvalve device, which has a simple structure in a single form or an array form and is easy to control, and an apparatus adopting the same.

2. Description of the Related Art

A valve device is used to switch the flow of a fluid or changing the path of the flow. In particular, a microvalve device is useful for a fluid control apparatus having microscale fluid channels. Various types of microvalves have been proposed, but they have complicated structures and are thus very difficult to manufacture.

David J. Beebe introduced a pH-sensitive hydrogel microvalve in U.S. Pat. No. 6,488,872 and in Nature vol. 404 (2000). The pH-sensitive hydrogel microvalve works using an acidic buffer or a basic buffer, which induces contraction and expansion of a hydrogel separated from a transfer fluid and thus needs a special valve for selectively supplying an acidic or alkaline buffer solution. U.S. Pat. No. 6,488,872 discloses a value having a structure like valves of the heart.

The subjects of study on a valve device are simplification of a structure, easiness of manufacturing, expansion of applicability, reduction of cost, etc. The present invention relates to a microvalve operating in a new manner and will solve the conventional problems.

### SUMMARY OF THE INVENTION

The present invention provides a valve device operating without a special buffer.

The present invention also provides a valve device which has a simple structure, is easy to manufacture, and high applicability.

According to an aspect of the present invention, there is provided a microvalve device including a channel through which a fluid flows, an actuator provided in the channel to close the channel due to pH-sensitive volume phase transition, and an electrode unit generating anions and cations by performing electrolysis of the fluid near the actuator.

The channel may include an inlet through which the fluid flows in, an outlet through which the fluid flows out, and an actuating chamber provided between the inlet and the outlet to contain the actuator.

The electrode unit may include an electrode disposed near the actuator and an electrode disposed near the outlet. Alternatively, the electrode unit may include an electrode disposed near the inlet and an electrode disposed near the outlet. As another alternative, the electrode unit may include electrodes disposed at opposite sides, respectively, of the actuating chamber.

The inlet may be connected to a center of the actuating chamber. The outlet may include a first outlet and a second outlet which are disposed at opposite sides, respectively, of the channel and through which the fluid flows in and flows out. The electrode unit may include a first electrode and a second electrode at opposite sides, respectively, of the actuating chamber, which are close to the first and second outlets, respectively. The actuator may include a first actuator and a second actuator which are close to the first and second electrodes, respectively. The first and second actuators may be made using the same material.

The channel may include four unit channels in a cross shape, and the actuator may be provided in each unit channel. Each unit channel may include two electrodes at both sides, respectively, along a path of the flowing fluid to face each other, and each electrode of the unit channel may be connected to an electrode of, an adjacent unit channel.

The actuator may be a hydrogel swelling or deswelling according to a pH change and stationed by an anchor.

According to another aspect of the present invention, there is provided a microvalve device including a plurality of unit valve devices connected to one another in an array form to control a flow of a fluid in a network structure, wherein each unit valve device includes a channel through which a fluid flows, an actuator provided in the channel to close the channel due to pH-sensitive volume phase transition, and an electrode unit generating anions and cations by performing electrolysis of the fluid near the actuator. The channel may include four unit channels in a cross shape, and the actuator may be provided in each unit channel. Each unit channel may include two electrodes at both sides, respectively, along a path of the flowing fluid to face each other, and each electrode of the unit channel may be connected to an electrode of an adjacent unit channel.

According to still another aspect of the present invention, there is provided a reaction apparatus including a channel having a reaction chamber and an inlet and an outlet through which a fluid flows in and out at opposite sides, respectively, of the reaction chamber; and a valve device having actuators provided at the inlet and the outlet, respectively, to close and open the channel due to pH-sensitive volume phase transition and electrode units generating anions and cations by performing electrolysis of the fluid near the actuators, respectively.

Each electrode unit may include a pair of electrodes disposed at the channel to be separated from each other by a predetermined distance and to face each other, and each actuator may be disposed near one of the electrodes.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates an experiment for testing deswelling and swelling of a hydrogel by electrolysis;

FIGS. 2A through 2C are photographs of states in which a polyacrylic acid (PAA) swells step by step in a 0.1 M NaCl solution at a pH of 7.0 without an electric field;

FIG. 2D is a graph showing the size of the swelling PAA versus time;

FIGS. 3A through 3D are photographs of states in which a PAA deswells step by step near a first electrode acting as an anode when an electric filed is induced and a positive voltage is applied to the first electrode after the PAA has swollen in a 0.1 M NaCl solution without an electric field for 15 minutes;

FIGS. 4A through 4C are photographs of states in which a PAA that has swollen near a second electrode acting as a cathode deswells over time due to the change in polarity of an applied voltage;

FIG. 4D is a graph showing the size of the deswelling PAA near the cathode versus time;

FIGS. 5A through 5D are photographs of states in which the PAA that has deswollen due to the second electrode acting an anode as shown in FIGS. 4B through 4C swells near the second electrode acting as a cathode when a negative voltage is applied to the second electrode;

FIGS. 6A through 6C are photographs of states in which a PAA that has deswollen near an electrode acting as an anode swells near the electrode acting as a cathode due to polarity change;

FIG. 6D is a graph showing the size of the PAA near the cathode versus time;

FIGS. 7A and 7B illustrate the schematic structure and operation of a microvalve device using an anionic type hydrogel as an actuator, according to a first embodiment of the present invention;

FIGS. 8A and 8B illustrate the schematic structure of a microvalve device using a cationic type hydrogel as an actuator, according to a second embodiment of the present invention;

FIGS. 9A and 9B illustrate the schematic structure of a microvalve device using an anionic type hydrogel as an actuator, according to a third embodiment of the present invention;

FIGS. 10A and 10B illustrate the schematic structure of a microvalve device using a cationic type hydrogel as an actuator, according to a fourth embodiment of the present invention;

FIGS. 11A through 11C illustrate the structure and operation of a microvalve device according to a fifth embodiment of the present invention;

FIGS. 12A and 12B illustrate the structure and operation of a microvalve device having four channels, according to a sixth embodiment of the present invention;

FIG. 13 illustrates an apparatus having a network structure by adopting the microvalve device according to the embodiment illustrated in FIGS. 12A and 12B, according to an embodiment of the present invention;

FIG. 14 illustrates an apparatus having a network structure by adopting the microvalve device according to the embodiment illustrated in FIGS. 12A and 12B, according to another embodiment of the present invention; and

FIGS. 15A and 15B illustrate the structure and operation of a reactor using an apparatus of the present invention.

### DETAILED DESCRIPTION OF THE INVENTION

Hereinafter, preferred embodiments of the present invention will be described in detail with reference to the attached drawings.

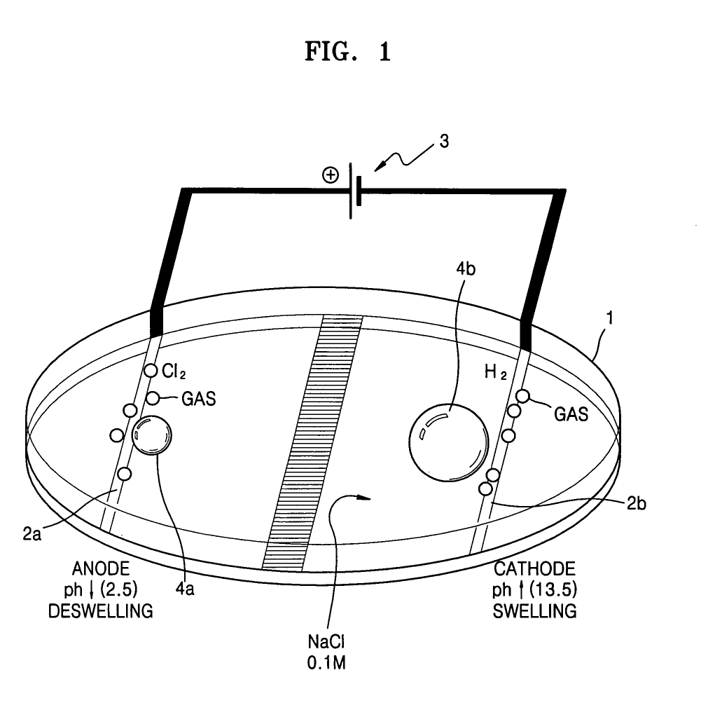

FIG. 1 illustrates an experiment for testing deswelling and swelling of a hydrogel by electrolysis. Referring to FIG. 1, a first electrode 2a and a second electrode 2b are disposed at opposite sides, respectively, of the bottom of a petri dish 1. 0.1 M NaCl is contained as a target object of electrolysis in the petri dish 1. The first electrode 2a and the second electrode 2b are each a gold wire having a diameter of 1 mm and act as an anode and a cathode, respectively, or a cathode and an anode, respectively. The first electrode 2a and the second electrode 2b are separated about 3 cm from each other and have a length of 3 cm. Such conditions are maintained in experiments described below. In FIG. 1, since a positive voltage is applied to the first electrode 2a, the first electrode 2a acts as an anode and the second electrode 2b acts as a cathode. A voltage of a power supply 3 applied to the first electrode 2a and the second electrode 2b is 5 V. Hydrogels 4a and 4b are anionic type hydrogels and positioned near the first electrode 2a and the second electrode 2b, respectively. A polyacrylic acid (PAA) is used as the hydrogels 4a and 4b. As a result of the experiment, a chloride ion (2Cl⁻) generated near the first electrode 2a acting as an anode was oxidized by electrolysis of NaCl to chloride (Cl) gas (see Formula 1). Accordingly, pH was lowered to about 2.5 near the first electrode 2a, and therefore, the hydrogel 4a deswelled.
2Cl⁻→Cl₂+2e⁻ (1)

Meanwhile, not Na⁺ but water was reduced near the second electrode 2b acting as a cathode to hydroxyl (OH⁻) and hydrogen (H₂) (see Formula 2). Accordingly, pH increased to 13.5, and therefore, the hydrogel 4b swelled.
2H₂O(l)+2e⁻→H₂(g)+2OH⁻(aq) (2)

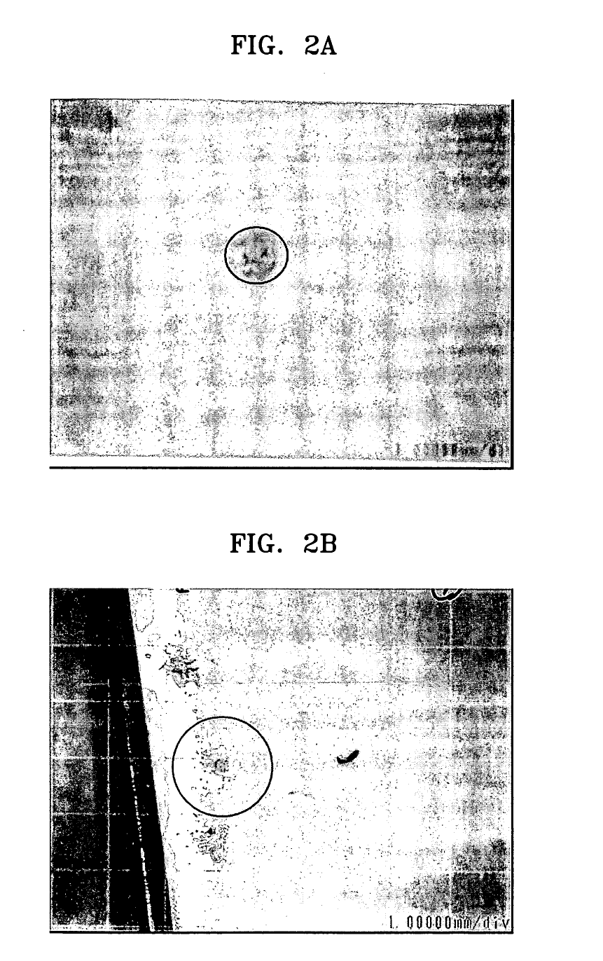

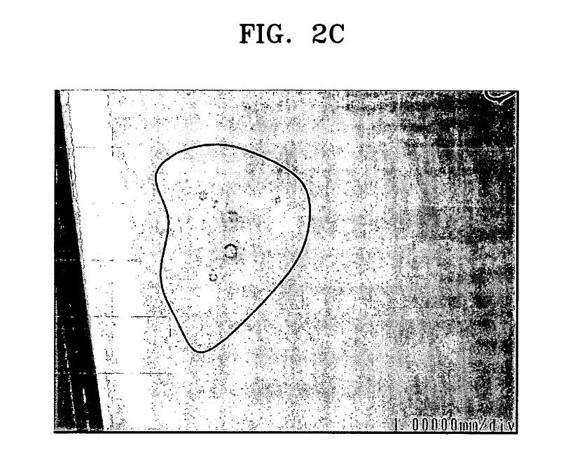

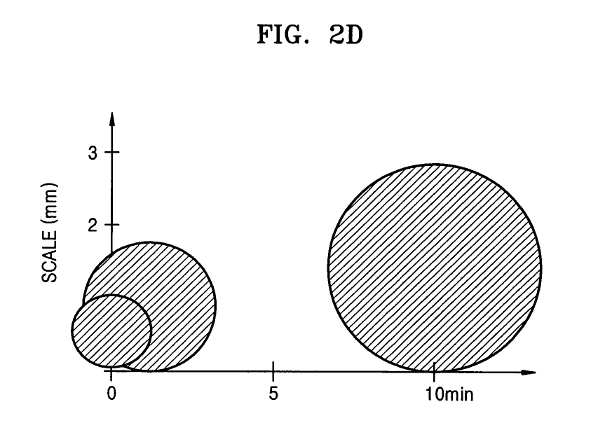

FIGS. 2A through 2C are photographs of states in Which a PAA swells step by step in a 0.1 M NaCl solution at a pH of 7.0 without an electric field. In FIGS. 2A through 2C, the PAA is shown within a black solid closed line. FIG. 2A shows an initial state in which the PAA does not swell without the electric field. FIG. 2B shows the state of the PAA one minute without the electric field. FIG. 2C shows the state of the PAA 10 minutes without the electric field. FIG. 2D is a graph showing the size of the swelling PAA versus time.

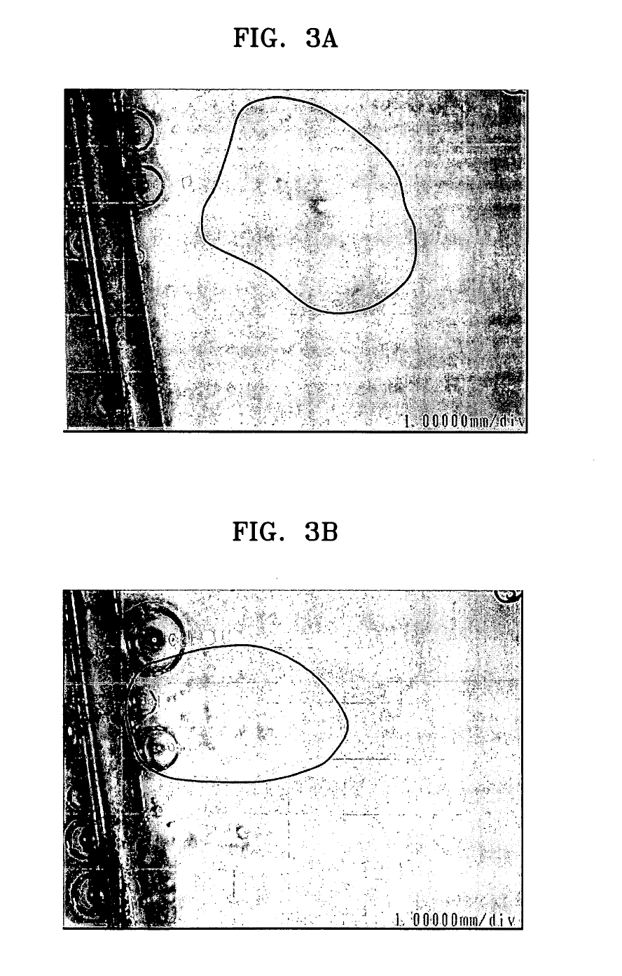

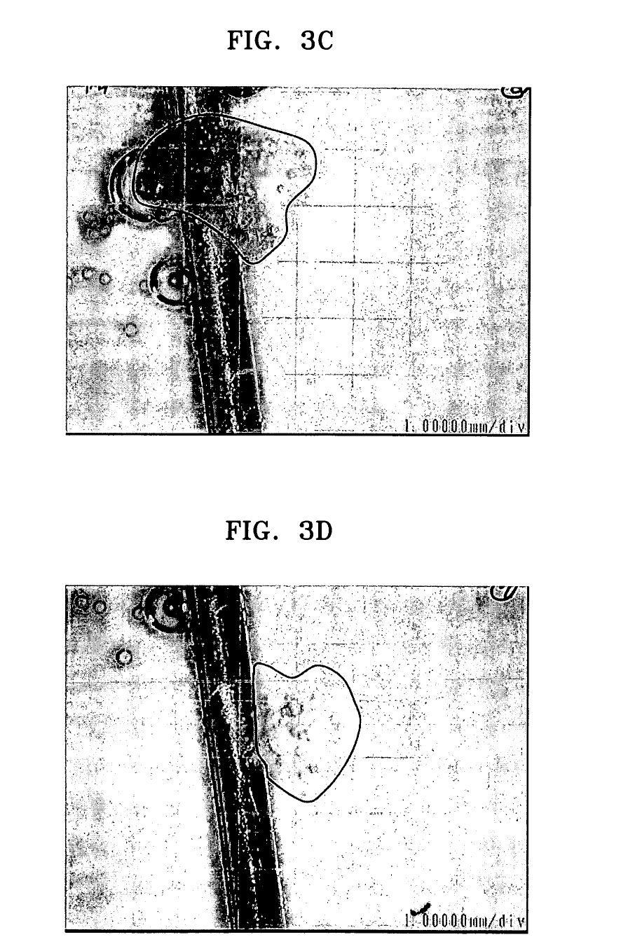

FIGS. 3A through 3D are photographs of states in which the PAA deswells step by step near a first electrode acting as an anode when an electric filed is induced and a positive voltage is applied to the first electrode after the PAA has swollen in the 0.1 M NaCl solution without the electric field for 15 minutes as shown in FIGS. 2A through 2B. Here, the voltage of a power supply is 5.0 V, current is 0.01 A, and pH is 2.5. In FIGS. 3A through 3D, large circles attached to the anode are bubbles created by generated gas. FIG. 3A shows the state of the PAA 5 minutes after the positive voltage is applied. FIG. 3B shows the state of the PAA 10 minutes after the positive voltage is applied. FIG. 3C shows the state of the PAA 15 minutes after the positive voltage is applied. FIG. 3D shows the state of the PAA 20 minutes after the positive voltage is applied. As shown in FIG. 3D, the PAA satisfactorily deswells. Meanwhile, the PAA will swell near a second electrode (not shown) acting as a cathode. Contrarily to an anionic type hydrogel, a cationic type hydrogel swells at an anode and deswells at a cathode.

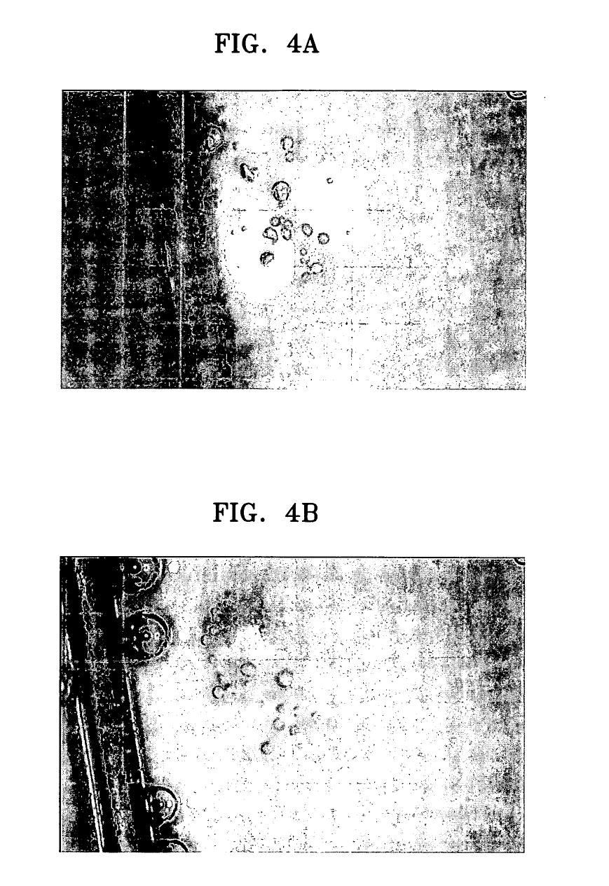

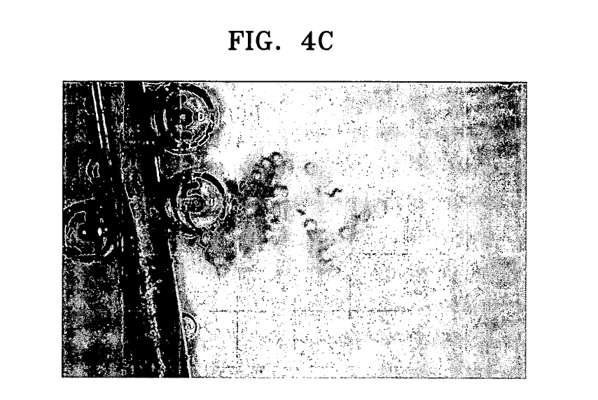

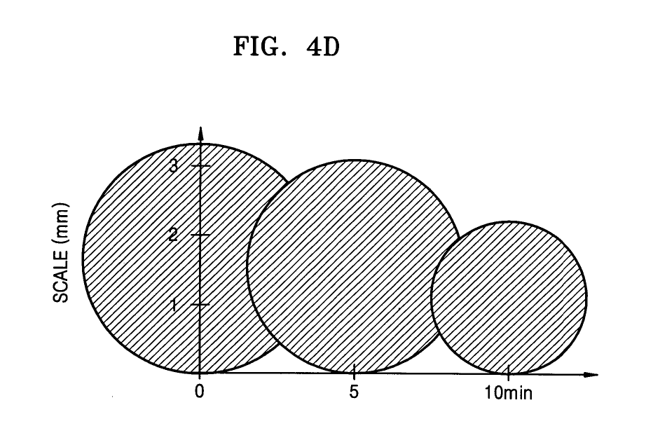

FIGS. 4A through 4C are photographs of states in which the PAA that has swollen near the second electrode acting as a cathode deswells over time due to the change in polarity of an applied voltage. FIG. 4A shows the PAA that has swollen near the second electrode acting as a cathode for 10 minutes under the conditions of 0.1 M NaCl, a pH of 13.5, a voltage of −5V, and a current of 0.01 A. FIGS. 4B and 4C show the states of the PAA at different times when a voltage having an opposite polarity, i.e., a positive voltage of 5 V is applied to the second electrode and thus the second electrode acts as an anode. FIG. 4B shows the state of the PAA 5 minutes after the positive voltage is applied and FIG. 4C shows the state of the PAA 10 minutes after the positive voltage is applied. FIG. 4D is a graph showing the size of the deswelling PAA versus time.

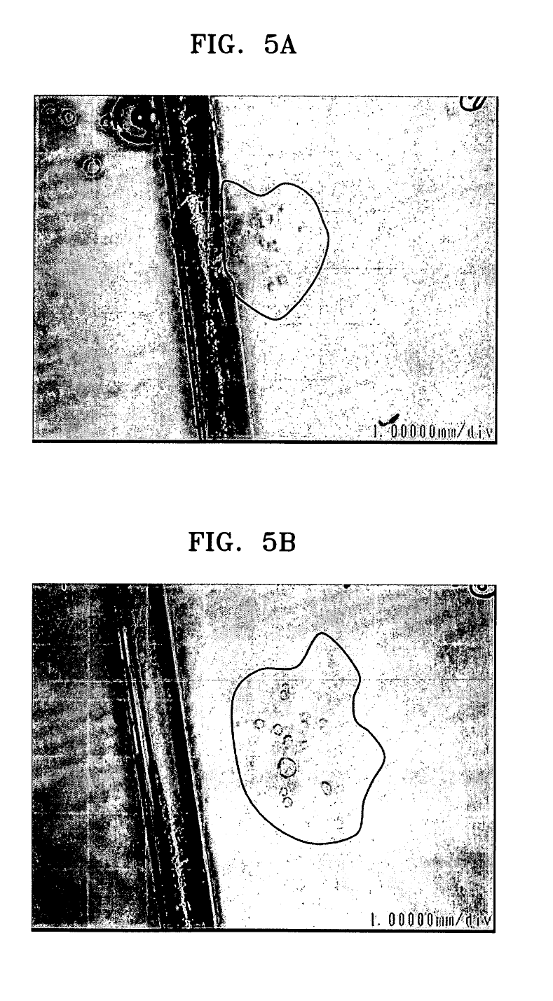

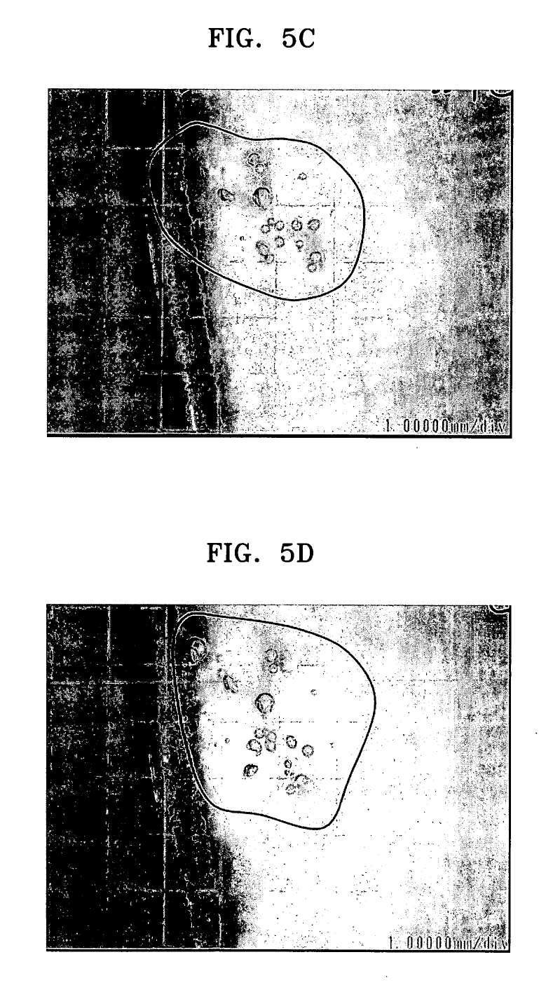

FIGS. 5A through 5D are photographs of states in which the PAA that has deswollen due to the second electrode acting an anode as shown in FIGS. 4B through 4C swells near the second electrode acting as a cathode when a negative voltage is applied to the second electrode. FIG. 5A shows the state of the PAA that has deswollen before the change of the polarity. FIGS. 5B through 5D shows the states of the PAA swelling over time after the change of the polarity. FIG. 5B shows the state of the PAA 5 minutes after the change of the polarity. FIG. 5C shows the state of the PAA 10 minutes after the change of the polarity. FIG. 5D shows the state of the PAA 15 minutes after the change of the polarity. During swelling, an environment is under the conditions of 0.1 M NaCl, a pH of 7.0, a voltage of −5 V, and a current of 0.01 A.

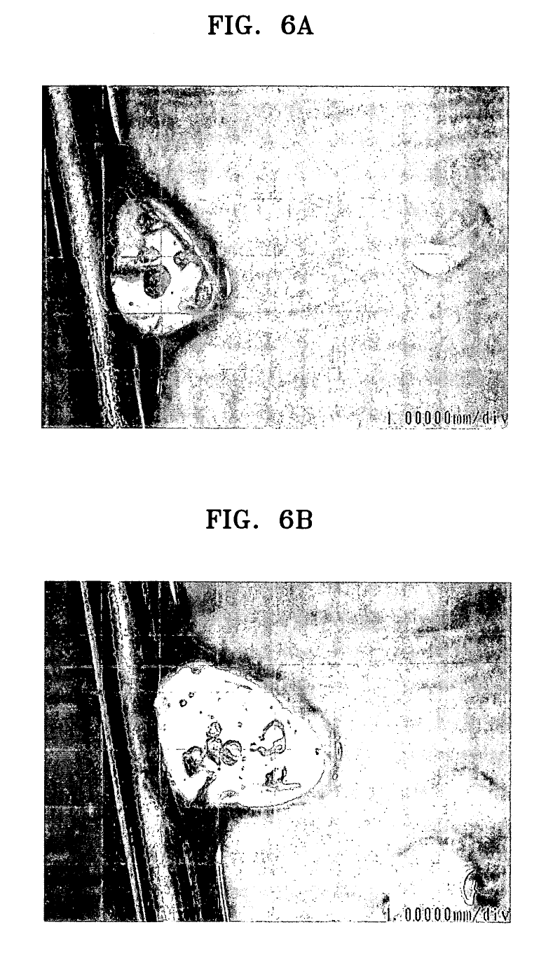

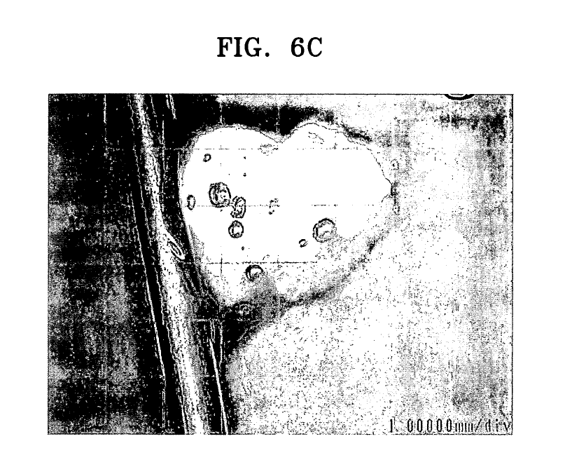

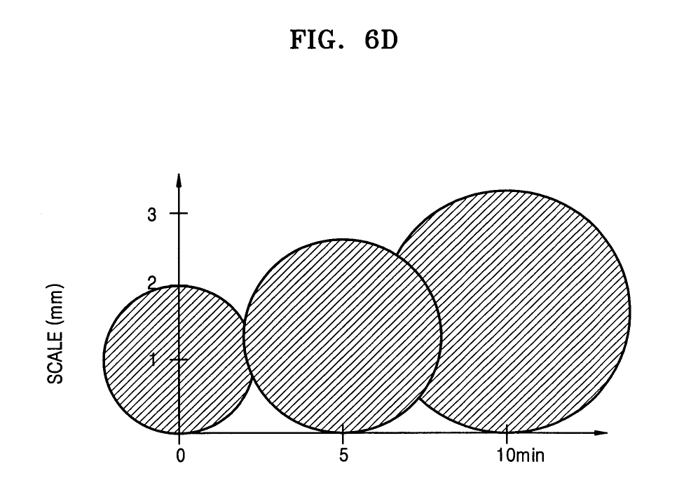

FIGS. 6A through 6C are photographs of states in which a PAA that has deswollen near an electrode acting as an anode swells near the electrode acting as a cathode due to polarity change. FIG. 6A shows the state of the PAA under the conditions of a pH of 2.5 and 0.1 M NaCl right before swelling. FIG. 6B shows the state of the PAA 5 minutes after the polarity change. FIG. 6C shows the state of the PAA 10 minutes after the polarity change. Here, an environment is under the conditions of 0.1 M NaCl, a pH of 7.0, a voltage of −5 V, and a current of 0.01 A. FIG. 6D is a graph showing the size of the PAA versus time. During swelling, an environment is under the conditions of 0.1 M NaCl, a pH of 13.5, a voltage of −5 V, and a current of 0.01 A.

It can be inferred from FIGS. 2A through 6D that when electrodes inducing electrolysis are disposed in a solution, swelling and deswelling or deswelling and swelling of a hydrogel are accomplished near a cathode and an anode, respectively.

Hereinafter, embodiments of the present invention using the above-described principle will be described in detail.

### First Embodiment

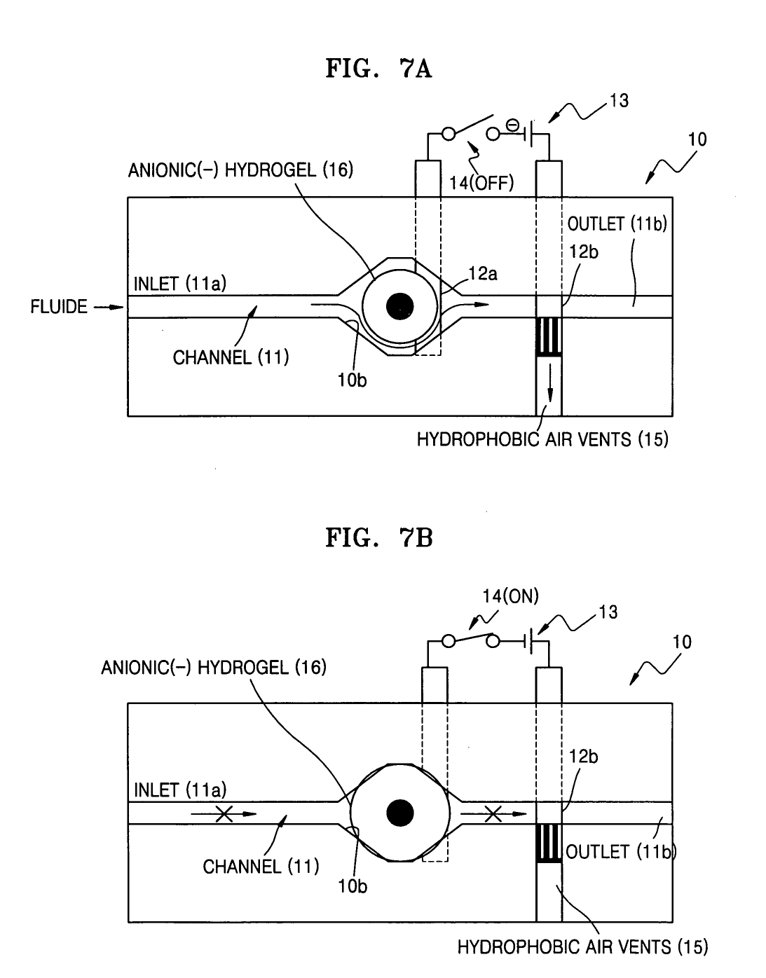

FIGS. 7A and 7B illustrate the schematic structure and operation of a normally open (NO) type microvalve device 10 using an anionic type hydrogel as an actuator. FIG. 7A shows a state where no voltage is applied and FIG. 7B shows a state where a valve operates in response to the application of a voltage.

Referring to FIG. 7A, the microvalve device 10 having a single path using micro electromechanical system (MEMS) technology includes a channel 11 through which a fluid flows and an actuating chamber 10b containing an actuator 16 in the middle of the channel 11. The actuator 16 is an anionic type hydrogel and has a size allowing the fluid to flow through the actuating chamber 10b in a normal state. An inlet 11a and an outlet 11b are provided at opposite sides, respectively, of the channel 11. A first electrode 12a is disposed at the actuating chamber 10b and a second electrode 12b is disposed near the outlet 11b of the channel 11 so that the fluid flowing between the actuating chamber 10b and the outlet 11b is subjected to electrolysis. In addition, a hydrophobic air vent 15 is provided near the second electrode 12b to discharge gas generated near the second electrode 12b. The fluid is a material to be transported and is not a special buffer solution used in a conventional valve device.

Referring to FIG. 7A, a power supply 13 is cut off by a switch 14 and electrolysis is not performed between the first and second electrodes 12a and 12b. Accordingly, the actuator, i.e., the anionic type hydrogel 16 remains in a normal size and the fluid flows.

Referring to FIG. 7B, the power supply 13 is connected to the first and second electrodes 12a and 12b by the closed switch 14 and the flowing fluid is dissociated in the channel 11 between the first and second electrodes 12a and 12b. Here, a negative voltage is applied to the first electrode 12a, and thus the first electrode 12a acts as a cathode. Accordingly, alkaline ions are generated near the cathode and thus pH increases. The actuator 16 contacting the alkaline ions swells and thus closes the channel 11 in the actuating chamber 10b. During electrolysis, one or more kinds of gas are generated and discharged through the hydrophobic air vent 15. In this state, when the switch 14 is open, the dissociation of the fluid stops and ions decrease or disappear. As a result, the actuator 16 deswells to the original state and the channel 11 is open.

### Second Embodiment

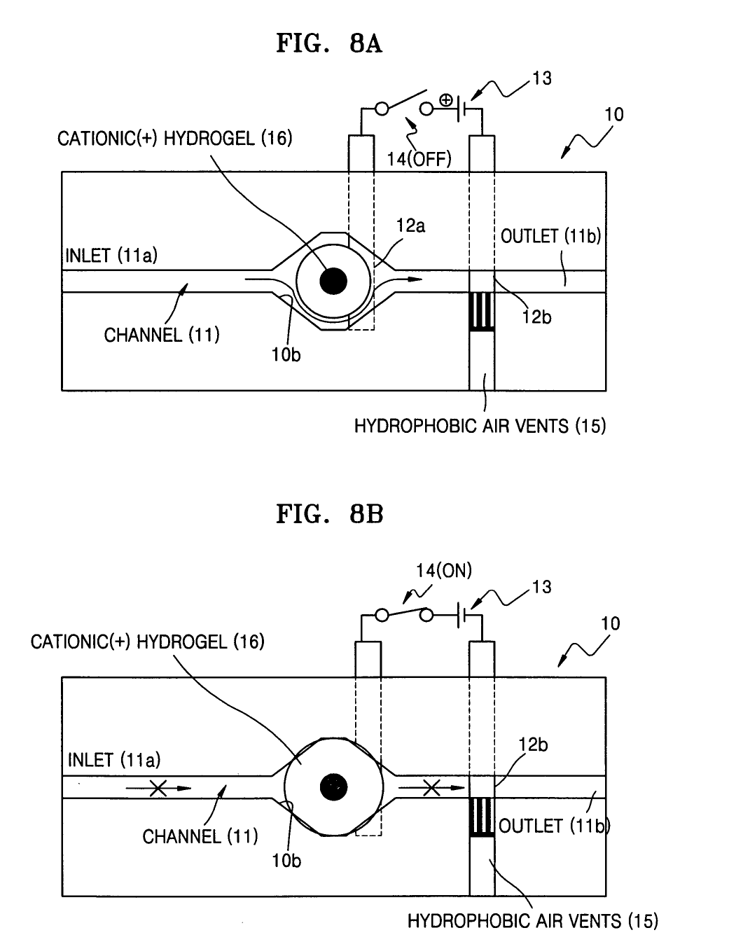

FIGS. 8A and 8B illustrate the schematic structure of an NO type microvalve device 10 using a cationic type hydrogel as an actuator. FIG. 8A shows a state where no voltage is applied and FIG. 8B shows a state where a valve operates in response to the application of a voltage. The microvalve device 10 shown in FIGS. 8A and 8B uses a cationic type hydrogel as an actuator, and therefore, a polarity of the applied voltage is different from that used in the microvalve device 10 shown in FIGS. 7A and 7B.

Referring to FIG. 8A, a power supply 13 is cut off by a switch 14 and electrolysis is not performed between first and second electrodes 12a and 12b. Accordingly, an actuator, i.e., a cationic type hydrogel 16 remains in a normal size and the fluid flows.

Referring to FIG. 8B, the power supply 13 is connected to the first ad second electrodes 12a and 12b by the closed switch 14 and the flowing fluid is dissociated in a channel 11 between the first and second electrodes 12a and 12b. Here, a positive voltage is applied to the first electrode 12a, and thus the first electrode 12a acts as an anode. Accordingly, acidic ions are generated near the anode and thus pH decreases. The actuator 16 contacting the acidic ions swells and thus closes the channel 11 in an actuating chamber 10b. Gas generated during electrolysis is discharged through a hydrophobic air vent 15. In this state, when the switch 14 is open, the dissociation of the fluid stops and ions decrease or disappear. As a result, the actuator 16 deswells to the original state and the channel 11 is open.

### Third Embodiment

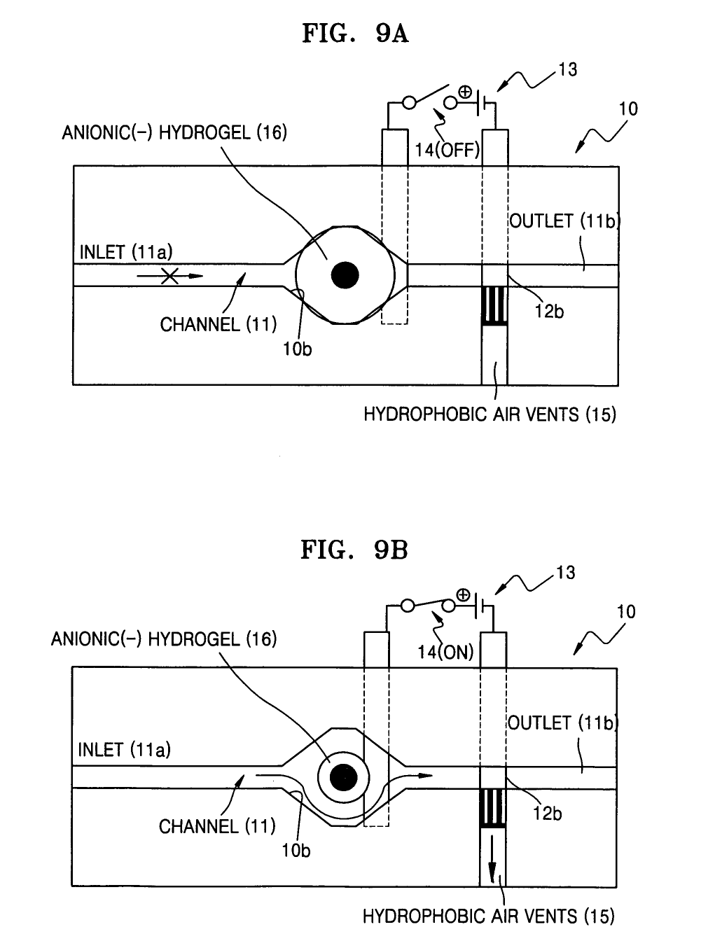

FIGS. 9A and 9B illustrate the schematic structure of a normally closed (NC) type microvalve device 10 using an anionic type hydrogel as an actuator. FIG. 9A shows a state where no voltage is applied and FIG. 9B shows a state where a valve operates in response to the application of a voltage.

Referring to FIG. 9A, the microvalve device 10 having a single path using MEMS technology includes a channel 11 through which a fluid flows and an actuating chamber 10b containing an actuator 16 in the middle of the channel 11. The actuator 16 is an anionic type hydrogel and has a sufficient size to block the flow of the fluid in the actuating chamber 10b in a normal state. Alternatively, the actuator 16 may swell due to the undissociated fluid sufficiently to block the flow of the fluid. For example, if the fluid is alkaline, the actuator 16 is in a swollen state while no voltage is applied. An inlet 11a and an outlet 11b are provided at opposite sides, respectively, of the channel 11. A first electrode 12a is disposed at the actuating chamber 10b and a second electrode 12b is disposed near the outlet 11b of the channel 11. In addition, a hydrophobic air vent 15 is provided near the second electrode 12b to discharge gas generated near the second electrode 12b.

Referring to FIG. 9A, a power supply 13 is cut off by a switch 14 and electrolysis is not performed between the first and second electrodes 12a and 12b. Accordingly, the actuator, i.e., the anionic type hydrogel 16 fills the actuating chamber 10b under the above-described conditions and the fluid does not flow.

Referring to FIG. 9B, the power supply 13 is connected to the first ad second electrodes 12a and 12b by the closed switch 14 and the flowing fluid is dissociated in the channel 11 between the first and second electrodes 12a and 12b. Here, a positive voltage is applied to the first electrode 12a, and thus the first electrode 12a acts as an anode. Accordingly, acidic ions are generated near the anode and thus pH decreases. The actuator 16 contacting the acidic ions deswells and thus allows the fluid to flow through the actuating chamber 10b. During electrolysis, one or more kinds of gas are generated and discharged through the hydrophobic air vent 15. In this state, when the switch 14 is open, the dissociation of the fluid stops and ions decrease or disappear. As a result, the actuator 16 returns to the original state or swells to the original state due to the contact with the alkaline fluid, and therefore, the flow of the fluid is interrupted.

### Fourth Embodiment

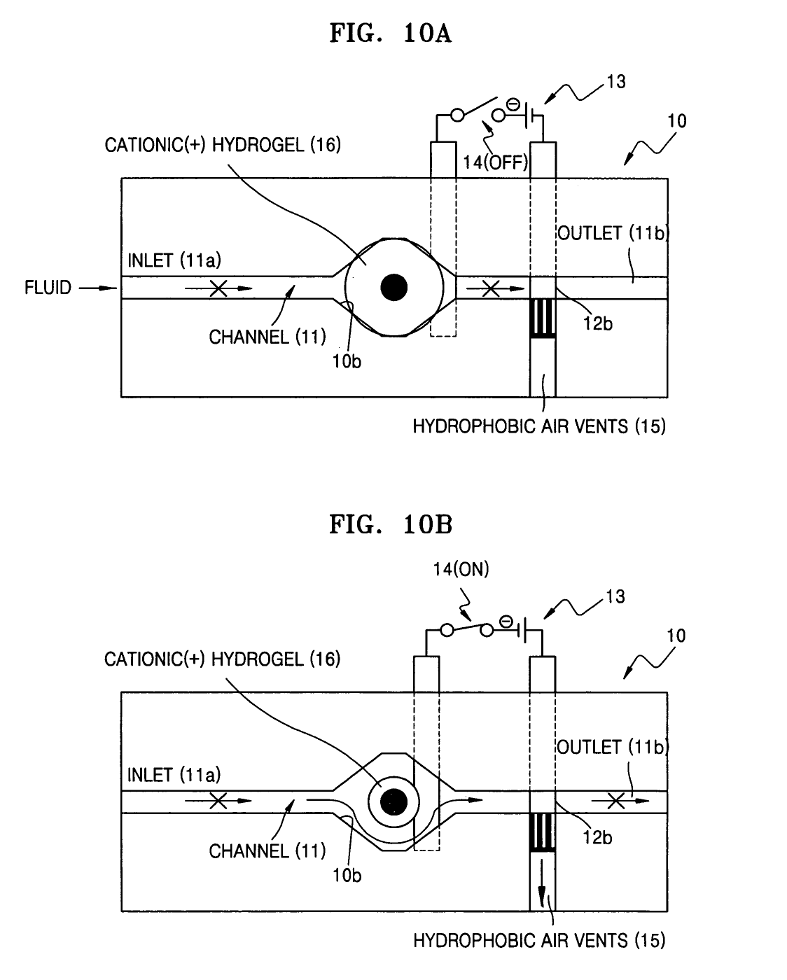

FIGS. 10A and 10B illustrate the schematic structure of an NC type microvalve device 10 using a cationic type hydrogel as an actuator. FIG. 10A shows a state where no voltage is applied and FIG. 10B shows a state where a valve operates in response to the application of a voltage.

Referring to FIG. 10A, the microvalve device 10 having a single path using MEMS technology includes a channel 11 through which a fluid flows and an actuating chamber 10b containing an actuator 16 in the middle of the channel 11. The actuator 16 is a cationic type hydrogel and has a sufficient size to block the flow of the fluid in the actuating chamber 10b in a normal state. Alternatively, the actuator 16 may swell due to the undissociated fluid sufficiently to block the flow of the fluid. For example, if the fluid is acidic, the actuator 16 is in a swollen state while no voltage is applied. An inlet 11a and an outlet 11b are provided at opposite sides, respectively, of the channel 11. A first electrode 12a is disposed at the actuating chamber 10b and a second electrode 12b is disposed near the outlet 11b of the channel 11. In addition, a hydrophobic air vent 15 is provided near the second electrode 12b to discharge gas generated near the second electrode 12b.

Referring to FIG. 10A, a power supply 13 is cut off by a switch 14 and electrolysis is not performed between the first and second electrodes 12a and 12b. Accordingly, the actuator, i.e., the cationic type hydrogel 16 fills the actuating chamber 10b under the above-described conditions and the fluid does not flow.

Referring to FIG. 10B, the power supply 13 is connected to the first ad second electrodes 12a and 12b by the closed switch 14 and the flowing fluid is dissociated in the channel 11 between the first and second electrodes 12a and 12b. Here, a negative voltage is applied to the first electrode 12a, and thus the first electrode 12a acts as a cathode. Accordingly, alkaline ions are generated near the cathode and thus pH increases. The actuator 16 contacting the alkaline ions deswells and thus allows the fluid to flow through the actuating chamber 10b. During electrolysis, one or more kinds of gas are generated and discharged through the hydrophobic air vent 15. In this state, when the switch 14 is open, the dissociation of the fluid stops and ions decrease or disappear. As a result, the actuator 16 returns to the original state or swells to the original state due to the contact with the acidic fluid, and therefore, the flow of the fluid is interrupted.

A microvalve device according to a fifth embodiment described below not only switches the flow of a fluid but also changes the path of the flow and is a modification of the microvalve devices according to the first through fourth embodiments. For clarity of the description, the microvalve device according to the fifth embodiment will be explained with reference to the drawings.

### Fifth Embodiment

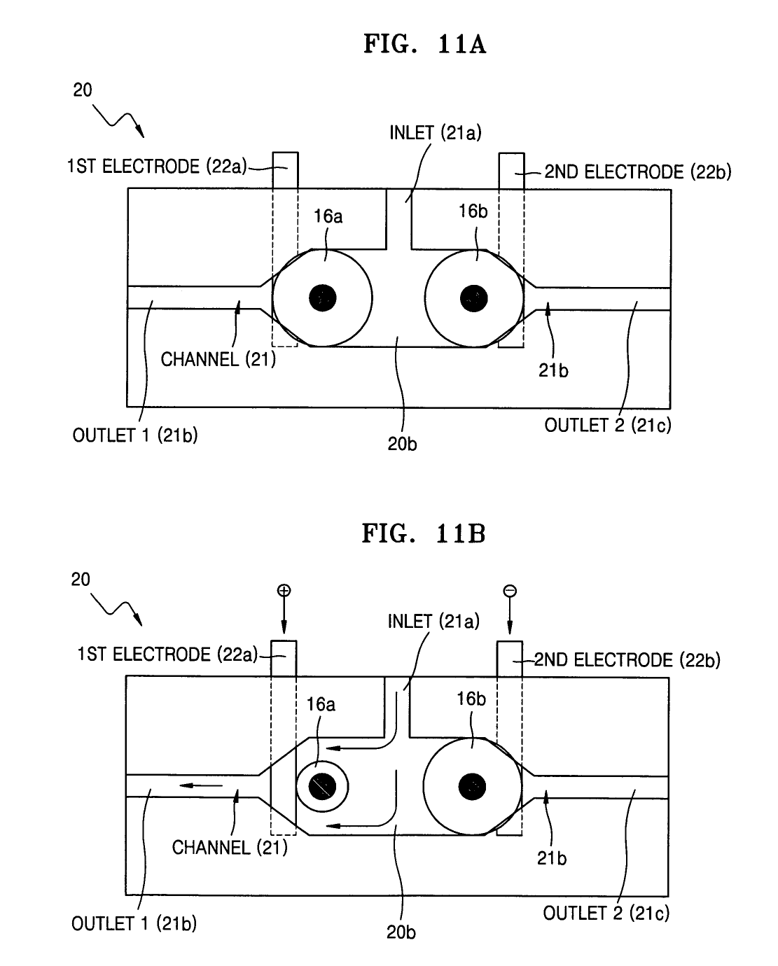

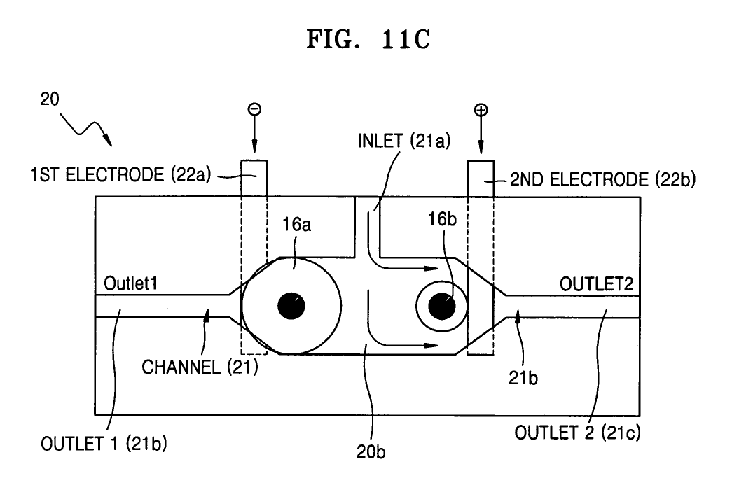

Referring to FIG. 11A, a microvalve device 20 manufactured using MEMS technology includes a channel 21 extending in a horizontal direction. An actuating chamber 20b is provided in the middle of the channel 21. An inlet 21a is provided at the upper center of the actuating chamber 20b. A first outlet 21b and a second outlet 21c are provided at the opposite ends, respectively, of the channel 21. A first electrode 22a and a second electrode 22b are provided at the opposite sides, respectively, of the actuating chamber 20b. A first actuator 16a and a second actuator 16b are provided near the first electrode 22a and the second electrode 22b, respectively. The first and second actuators 21a and 21b are implemented as an anionic type or cationic type hydrogel according to the pH of a fluid. For example, when the fluid is NaCl, the first and second actuators 16a and 16b are a PAA. When the fluid is an acid, the first and second actuators 16a and 16b are poly diethylaminoethyl methacrylate (PDEAEM). Accordingly, when there is no electric field, the first and second actuators 16a and 16b are in a swollen state due to an acidic or alkaline fluid existing in the channel 21 and the actuating chamber 20b so that the first and second actuators 16a and 16b close the opposite sides of the actuating chamber 20b and interrupt the discharge of the fluid through the first and second outlets 21a and 21b.

Referring to FIG. 11B, when a positive voltage is applied to the first electrode 22a and a negative voltage is applied to the second electrode 22b, the fluid in the actuating chamber 20b dissociates, and therefore, pH decreases near the first electrode 22a acting as an anode and increases near the second electrode 22b acting as a cathode. Accordingly, the first actuator 16a at the first electrode 22a deswells while the second actuator 16b at the second electrode 22b remains swollen. As a result, the fluid flowing in through the inlet 21a is discharged through the first outlet 21b.

Referring to FIG. 11C, when a negative voltage is applied to the first electrode 22a and a positive voltage is applied to the second electrode 22b, the fluid in the actuating chamber 20b dissociates, and therefore, pH increases near the first electrode 22a acting as a cathode and decreases near the second electrode 22b acting as an anode. Accordingly, the first actuator 16a at the first electrode 22a remains swollen while the second actuator 16b at the second electrode 22b deswells. As a result, the fluid flowing in through the inlet 21a is discharged through the second outlet 21c.

As shown in FIGS. 11A through 11C, a microvalve device according to an embodiment of the present invention may completely interrupt a fluid or selectively allows the fluid to flow. The fluid may be interrupted or allowed to flow according to a property of an actuator or the kind of fluid.

A microvalve device according to a sixth embodiment described below includes a plurality of paths, actuators, and corresponding electrodes.

### Sixth Embodiment

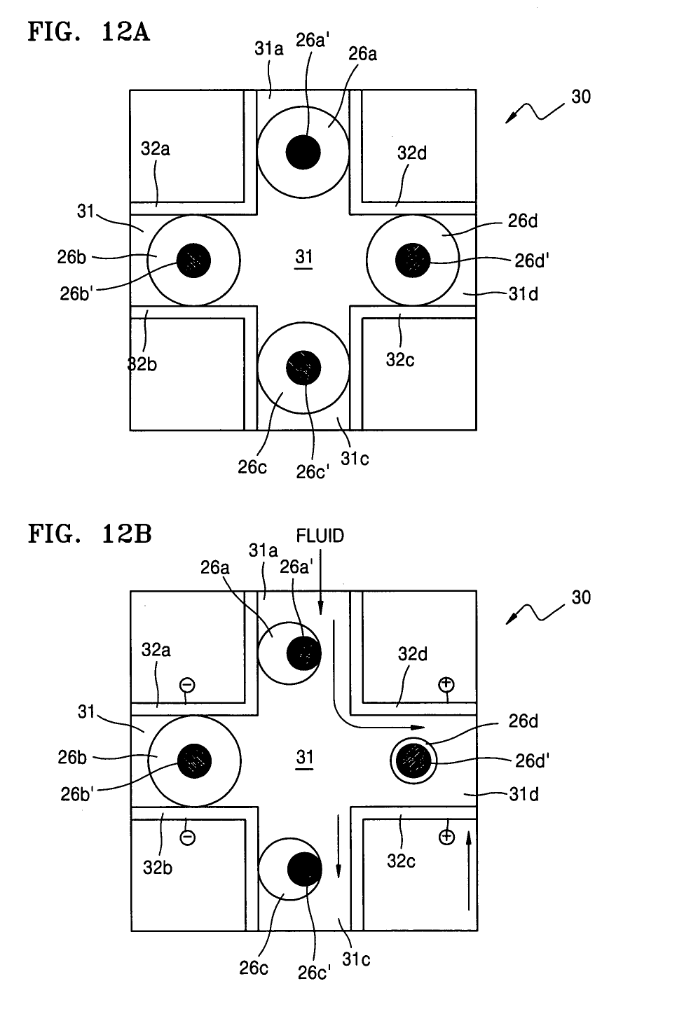

Referring to FIG. 12A, a microvalve device 30 includes a cross-shape channel 31 having four unit channels 31a, 31b, 31c, and 31d. Bent electrodes 32a, 32b, 32c, and 32d are each formed along the sides of adjacent unit channels so that they face one another. Here, a single bent electrode is shared by two adjacent unit channels. Actuators 26a, 26b, 26c, and 26d are respectively disposed at the centers of the respective unit channels 31a, 31b, 31c, and 31d to close the respective unit channels 31a, 31b, 31c, and 31d in a normal state. The actuators 26a, 26b, 26c, and 26d are stationed by anchors 26a′, 26b′, 26c′, and 26d′, respectively, provided at their centers. In the sixth embodiment of the present invention, a PAA deswelling in response to an alkali is used as an actuator and a NaCl solution is used as a fluid.

FIG. 12B shows a path of the flowing fluid, which is determined in the cross-shape channel 31 by overall deswelling and swelling and partial deswelling and swelling of the actuators 26a, 26b, 26c, and 26d according to the polarity of a voltage applied to each of the bent electrodes 32a, 32b, 32c, and 32d. As show in FIG. 12B, a negative voltage is applied to the first and second electrodes 32a and 32b and a positive voltage is applied to the third and fourth electrodes 32c and 32d. In such voltage application, a portion of an actuator near an electrode to which the positive voltage is applied deswells and a portion of the actuator near an electrode to which the negative voltage is applied remains swollen.

When the voltages are applied, dissociation of the fluid occurs between each of the electrodes 32c and 32d acting as an anode and each of the electrodes 32a and 32b acting as a cathode.

In this situation, a portion of the first actuator 26a and a portion of the third actuator 26c, which are adjacent to the fourth electrode 32d and the third electrode 32c to which the positive voltage is applied, deswell and allow the fluid to flow. Meanwhile, the second actuator 26b positioned between the first electrode 32a and the second electrode 32b remains swollen and closes the path of the fluid. The fourth actuator 26d positioned between the third electrode 32c and the fourth electrode 32d deswells entirely and allows the fluid to flow.

Since the centers of the respective actuators 26a, 26b, 26c, and 26d are stationed by the anchors 26a′, 26b′, 26c′, and 26d′, respectively, the actuators 26a, 26b, 26c, and 26d entirely or partially deswell or swell without the movement of their centers and thus switch the path of the fluid.

In the microvalve device according to the sixth embodiment of the present invention, unit valves are arranged in an array to form an interconnected network so that a fluid is transported in a particular direction. In addition, a plurality of inlets and outlets are provided in the network so that fluids may be mixed and transported to one or more target points.

### Seventh Embodiment

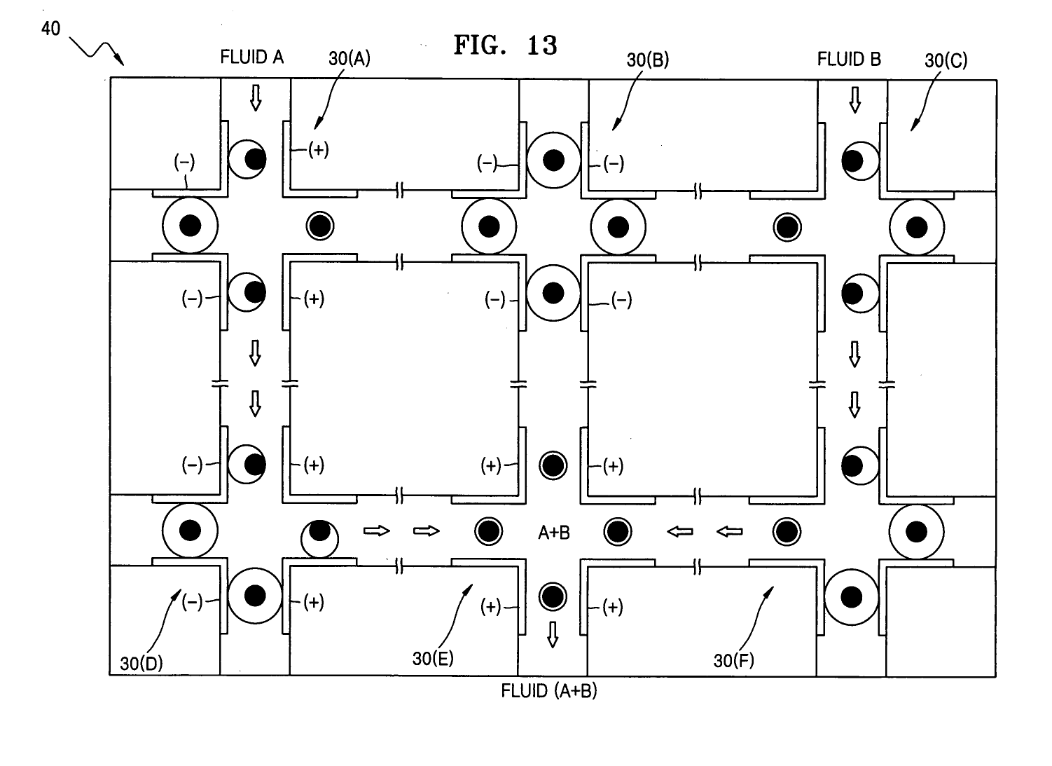

A microvalve device 40 having a network structure shown in FIG. 13 may be manufactured using MEMS technology. The microvalve device 40 has a structure in which a plurality of the microvalve devices 30 (hereinafter, referred to as unit valve devices) according to the sixth embodiment are arranged to be interconnected to one another. Electrodes of the unit valve devices 30 are also connected through an electrical circuit. The structure and operation of the unit valve devices 30 have been described with reference to FIGS. 12A and 12B, and thus a description thereof will be omitted. In addition, deswelling and swelling of actuators in each unit valve device according to the polarity of an applied voltage have also been described.

Referring to FIG. 13, the microvalve device 40 includes a lattice shape channel which is a group of the cross-shape channels of the unit valve devices 30.

The microvalve device 40 shown in FIG. 13 includes 6 unit valve devices and the deswelling or swelling of an actuator is determined by the polarity of a voltage applied to each electrode included in the microvalve device 40.

According to voltage application show in FIG. 13, an upper portion of a first unit valve device 30(A) at an upper left portion and an upper portion of a third unit valve device 30(C) at an upper right portion are open so that different kinds of fluids A and B flow in. A second unit valve device 30(B) between the first and second unit valve devices 30(A) and 30(C) closes the path of the fluids A and B since a negative voltage is applied to all electrodes of the second unit valve device 30(B), and therefore, there is no direct connection of the path between the first unit valve device 30(A) and the third unit valve device 30(C).

The fluid A flowing into the first unit valve device 30(A) flows into a fifth unit valve device 30(E) via a fourth unit valve device 30(D) disposed below the first unit valve device 30(A). Meanwhile, the fluid B flowing into the third unit valve device 30(C) flows into the fifth unit valve device 30(E) via a sixth unit valve device 30(F) disposed below the third unit valve device 30(C).

As a result, the fluids A and B flowing into the fifth unit valve device 30(E) are mixed and then discharged through a lower portion of the fifth unit valve device 30(E).

As described above, different kinds of fluids flowing in through different paths may be mixed and then discharged through one path. Alternatively, the different kinds of fluids may not be mixed and may be discharged through different paths, respectively, according to the manner of applying a voltage. Two or more kinds of fluids may be allowed to flow in and may be controlled and transported in various ways according to the design and scale of the network.

The network shown in FIG. 13 includes only 6 unit valve devices, but a large-scaled microfluidic valve network may be constructed using several tens or hundreds of unit valve devices.

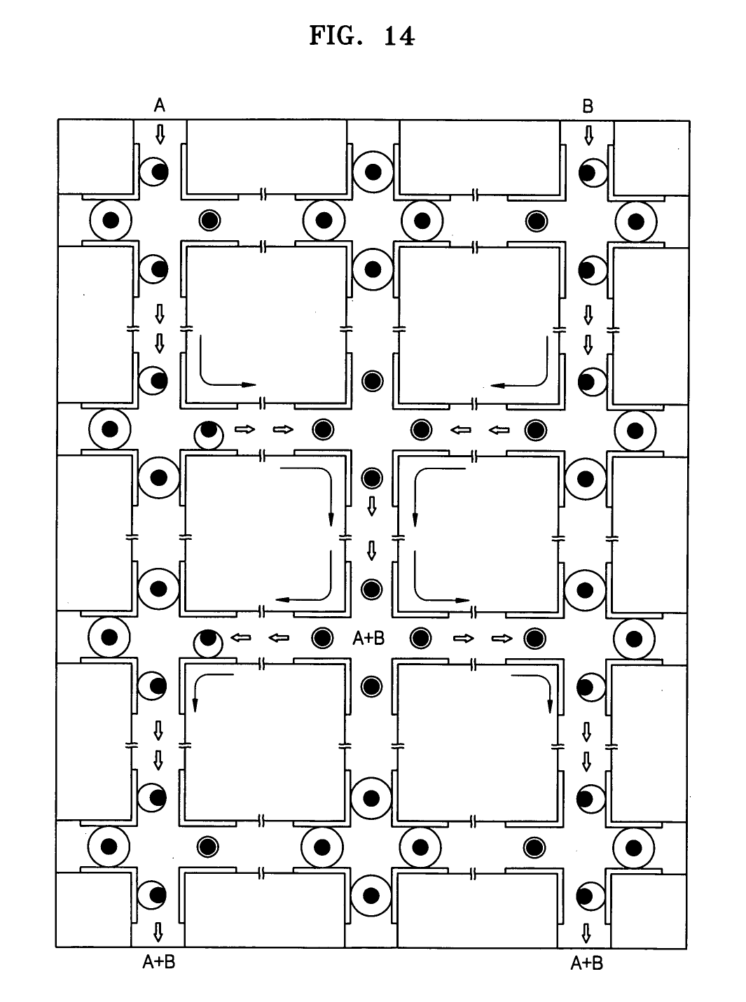

FIG. 14 shows a network using 12 unit valve devices. The operation of each unit valve device shown in FIG. 14 will be understood based on the above description. As shown in FIG. 14, the unit valve devices have various states such that different kinds of fluids A and B flowing in through different paths, respectively, are mixed in one unit valve device (at the center of the network). A mixed fluid A+B is discharged through different paths.

In an eighth embodiment described below, the microvalve device 40 is adapted for a polymerase chain reaction (PCR) apparatus.

### Eighth Embodiment

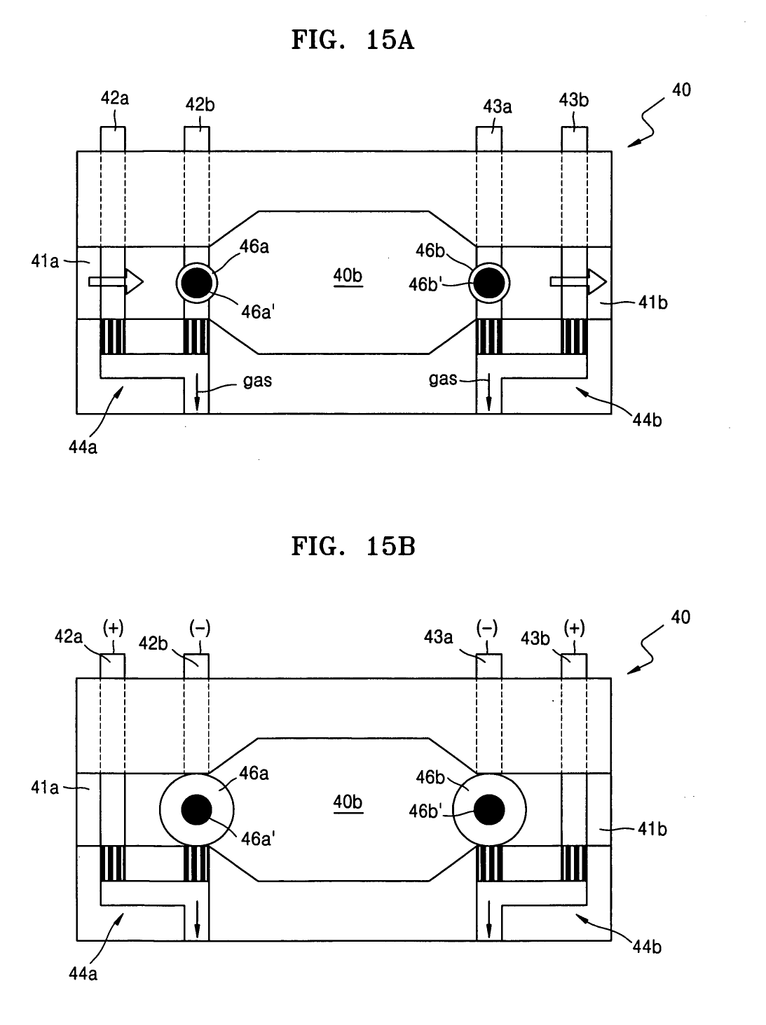

A reaction apparatus 40 shown in FIG. 15A is manufactured using MEMS technology. A micro reaction chamber 40b is provided on a path of a flowing fluid. An inlet 41a and an outlet 41b are provided in predetermined length at opposite sides, respectively, of the micro reaction chamber 40b. A first electrode 42a and a second electrode 42a and 42b are provided at the inlet 41a to control the inflow of the fluid. A third electrode 43a and a fourth electrode 43b are provided at the outlet 41b to control the outflow of the fluid. A first actuator 46a and a second actuator 46b are provided near or on the second electrode 42b and the third electrode 43a, respectively, and are stationed by their respective anchors 46a′ and 46b′. While no voltage is applied to the first through fourth electrodes 42a, 42b, 43a, and 43b, the first and second actuators 46a and 46b have a size allowing the fluid to flow. Accordingly, in this state, the fluid is not controlled but flows into the micro reaction chamber 40b. Meanwhile, hydrophobic air vents 44a and 44b are provided near the first through fourth electrodes 42a, 42b, 43a, and 43b using a micro structure or the like. The hydrophobic air vent may be eliminated or more hydrophobic air vents may be added when needed.

Referring to FIG. 15B, voltages are applied to the first through fourth electrodes 42a, 42b, 43a, and 43b, and thus the micro reaction chamber 40b is closed by the first and second actuators 46a and 46b that have swollen. Here, the fluid is confined to the micro reaction chamber 40b. In this situation, a certain reaction, e.g., a PCR, may be executed according to a purpose.

According to the present invention, a valve device using a pH-sensitive hydrogel does not use a buffer solution besides a transfer fluid and operates using the transfer fluid. Such valve device realizes a bistable valve device according to the direction and state of dissociation. Such valve device can be easily accomplished using MEMS technology used to manufacture a mechanical micro structure. An actuator of the valve device is a polymer and can be easily formed within a MEMS structure using typical photolithography or the like.

Such valve device according to the present invention can be used in various fields, for example, chemical reaction/analysis systems such as LIP, LOC, and u-TAS.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A microvalve device comprising:
a channel through which a fluid flows;
an actuator provided in the channel to close the channel due to pH-sensitive volume phase transition; and
an electrode unit generating anions and cations by performing electrolysis of the fluid near the actuator.

2. The microvalve device of claim 1, wherein the channel comprises:
an inlet through which the fluid flows in;
an outlet through which the fluid flows out; and
an actuating chamber provided between the inlet and the outlet to contain the actuator.

3. The microvalve device of claim 2, wherein the electrode unit comprises an electrode disposed near the actuator and an electrode disposed near the outlet.

4. The microvalve device of claim 1, wherein the electrode unit comprises an electrode disposed near the inlet and an electrode disposed near the outlet.

5. The microvalve device of claim 1 wherein the electrode unit comprises an electrode disposed near the inlet and an electrode disposed near the outlet.

6. The microvalve device of claim 2, wherein the inlet is connected to a center of the actuating chamber;
the outlet comprises a first outlet and a second outlet which are disposed at opposite sides, respectively, of the channel and through which the fluid flows in and flows out, respectively;
the electrode unit comprises a first electrode and a second electrode at opposite sides, respectively, of the actuating chamber which are close to the first and second outlets, respectively; and
the actuator comprises a first actuator and a second actuator which are close to the first and second electrodes, respectively.

7. The microvalve device of claim 6, wherein the first and second actuators are made using materials having the same properties.

8. The microvalve device of claim 1, wherein the channel comprises four unit channels in a cross shape, and the actuator is provided in each unit channel.

9. The microvalve device of claim 8, wherein each unit channel comprises two electrodes at both sides, respectively, along a path of the flowing fluid to face each other; and each electrode of the unit channel is connected to an electrode of an adjacent unit channel.

10. The microvalve device of claim 1, wherein the actuator is a hydrogel.

11. The microvalve device of claim 10, further comprising a hydrophobic air vent connected to the channel.

12. The microvalve device of claim 1, further comprising a hydrophobic air vent connected to the channel.

13. The microvalve device of claim 1, wherein the actuator is stationed by an anchor.

14. A microvalve device comprising a plurality of unit valve devices connected to one another in an array form to control a flow of a fluid in a network structure, wherein each unit valve device comprises:
a channel through which a fluid flows;
an actuator provided in the channel to close the channel due to pH-sensitive volume phase transition; and
an electrode unit generating anions and cations by performing electrolysis of the fluid near the actuator.

15. The microvalve device of claim 14, wherein the channel comprises four unit channels in a cross shape, and the actuator is provided in each unit channel.

16. The microvalve device of claim 15, wherein each unit channel comprises two electrodes at both sides, respectively, along a path of the flowing fluid to face each other; and each electrode of the unit channel is connected to an electrode of an adjacent unit channel.

17. The microvalve device of claim 14, wherein the actuator is a hydrogel.

18. The microvalve device of claim 14, wherein the actuator is stationed by an anchor.

19. A reaction apparatus comprising:
a channel having a reaction chamber and an inlet and an outlet through which a fluid flows in and out at opposite sides, respectively, of the reaction chamber; and
a valve device having actuators provided at the inlet and the outlet, respectively, to close and open the channel due to pH-sensitive volume phase transition and electrode units generating anions and cations by performing electrolysis of the fluid near the actuators, respectively.

20. The reaction apparatus of claim 19, wherein each electrode unit comprises a pair of electrodes disposed at the channel to be separated from each other by a predetermined distance and to face each other, and each actuator is disposed near one of the electrodes.

21. The reaction apparatus of claim 20, wherein the actuators are made using the same material.

22. The reaction apparatus of claim 19, wherein each actuator is stationed by an anchor.
